(19) United States
(12) Patent Application Publication
(10) Pub. No.: US 2025/0345786 A1
(43) Pub. Date: Nov. 13, 2025

(54) DIAGNOSTIC CARTRIDGE AND SEMICONDUCTOR BIOSENSOR DIAGNOSTIC SYSTEM COMPRISING THEREOF

(71) Applicant: BIOUP LABS TAIWAN CO., LTD., Hsinchu County (TW)

(72) Inventors: Kun Lung Chen, Xinzhu County (TW); Ke Pan Liao, Hsinchu County (TW); Lin Ai Tai, Hsinchu County (TW)

(21) Appl. No.: 18/656,994

(22) Filed: May 7, 2024

(51) Int. Cl. B01L 3/00

(52) U.S. Cl. CPC B01L 3/502; B01L 2200/16; B01L 2300/0609

(57) ABSTRACT

A semiconductor biosensor diagnostic system is provided. The semiconductor biosensor diagnostic system includes a diagnostic cartridge and a cartridge diagnostic base. The diagnostic cartridge includes a biosensor device and a fluid-guide body over the biosensor device. The fluid-guide body includes a first pumping opening, a second pumping opening, a buffer reservoir, a sample reservoir, and a plurality of channels configured to provide a first loop including the first pumping opening and the buffer reservoir, and a second loop including the second pumping opening and the sample reservoir. The first loop and the second loop sharing a common channel passing through the biosensor device. The cartridge diagnostic base includes a plurality of micro pumps coupled to the first pumping opening and the second pumping opening, and a sensing structure configured to receive a sensing information from the biosensor device.

### FIELD

The present disclosure relates to a diagnostic cartridge and semiconductor biosensor diagnostic system comprising thereof, particularly, the disclosed diagnostic cartridge applied in the semiconductor biosensor diagnostic system is a portable device and includes a pumping mechanism that the biomedical sample and the buffer liquid can be precisely guided to in contact with an electrical based biosensor chip inside the diagnostic cartridge.

### BACKGROUND

The use of biosensing instruments using disposable sample pieces has been increasing each year, and it is expected to enable simple and quick assay and analysis of a particular component in a biological body fluid such as blood, plasma, urine, saliva, or the whole set of proteins created in a cell at a certain point in time, i.e., a proteome. Moreover, individually tailored medical treatments, in which individuals are treated and administered medicines according to their SNP (acronym for Single Nucleotide Polymorphism) information, are expected to be put into practice in the future by genetic diagnosis using disposable DNA chips. This personalized approach will be supported by protein and DNA diagnostics. Disposable semiconductor biosensor devices and its electronic analyzer with affordable cost will play a crucial role, enabling rapid detection and diagnosis of challenging diseases such as Alzheimer's disease and cancer through liquid biopsy techniques.

### BRIEF DESCRIPTION OF THE DRAWINGS

Aspects of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1A illustrates a cross-sectional view of a diagnostic cartridge according to some embodiments of the present disclosure.

FIG. 1B illustrates a cross-sectional view of a diagnostic cartridge according to some embodiments of the present disclosure.

FIG. 2 illustrates a cross-sectional view of an integrated biosensor structure according to some embodiments of the present disclosure.

FIG. 3 illustrates a cross-sectional view of an integrated biosensor structure according to some embodiments of the present disclosure.

FIG. 4 illustrates a cross-sectional view of an integrated biosensor structure according to some embodiments of the present disclosure.

FIG. 5A illustrates a top view of a PCB according to some embodiments of the present disclosure.

FIG. 5B illustrates a bottom view of a PCB according to some embodiments of the present disclosure.

FIG. 6A illustrates a cross-sectional view of a diagnostic cartridge according to some embodiments of the present disclosure.

FIG. 6B illustrates a top view of the positions of the reservoirs and the pumping openings in the diagnostic cartridge according to some embodiments of the present disclosure.

FIG. 6C illustrates a top view of the positions of the reservoirs and the pumping openings in the diagnostic cartridge according to some embodiments of the present disclosure.

FIG. 7A illustrates a cross-sectional view of a diagnostic cartridge according to some embodiments of the present disclosure.

FIG. 7B illustrates a top view of the positions of the reservoirs and the pumping openings in the diagnostic cartridge according to some embodiments of the present disclosure.

FIG. 7C illustrates a top view of the positions of the reservoirs and the pumping openings in the diagnostic cartridge according to some embodiments of the present disclosure.

FIG. 8 illustrates a cross-sectional view of a diagnostic cartridge according to some embodiments of the present disclosure.

FIG. 9 illustrates a cross-sectional view of a diagnostic cartridge according to some embodiments of the present disclosure.

FIG. 10 illustrates a cross-sectional view (schematic diagram) of a diagnostic cartridge and a diagnostic cartridge base according to some embodiments of the present disclosure.

FIG. 11 illustrates a cross-sectional view (schematic diagram) of a diagnostic cartridge base according to some embodiments of the present disclosure.

FIG. 12A illustrates a cross-sectional view of a diagnostic cartridge according to some embodiments of the present disclosure.

FIG. 12B illustrates a cross-sectional view of a diagnostic cartridge according to some embodiments of the present disclosure.

FIG. 13 illustrates a three-dimensional diagram of a semiconductor biosensor diagnostic system according to some embodiments of the present disclosure.

FIGS. 14A-14D illustrate cross-sectional views of an operating process of a semiconductor biosensor diagnostic system according to some embodiments of the present disclosure.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper”, “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first”, “second” and “third” describe various elements, components, regions, layers and/or sections, these elements, components, regions, layers and/or sections should not be limited by these terms. These terms may be only used to distinguish one element, component, region, layer or section from another. The terms such as “first”, “second”, and “third” when used herein do not imply a sequence or order unless clearly indicated by the context.

In the course diagnostic test, biomedical samples are usually placed in the biomedical sensor and the results of the diagnosis are presented visually, for instance, the color change of biomedical samples, the light reflected by the biomedical samples, the visibility of the lines show in the test kits (e.g., pregnancy test kit, COVID-19 test kit, influenza test kit), the fluorescent reaction of the biomedical samples, the visible marks show in the test strips, etc. In some comparative embodiments, once the color of the biomedical sample is changed during the diagnosis, the result can be observed with the naked eye, or some CMOS image sensors can be used to monitor such visible change for further analysis. These optical-based diagnosis approaches or the usage of optical-based sensors are widely used for fluidic biomedical samples, such as DNA-containing fluids, blood, interstitial fluid in subcutaneous tissue, muscle or brain tissue, urine, or other body fluids.

However, from the perspective of component volume, optical-based diagnostic approaches or sensors are generally more challenging to miniaturize compared to electrical-based ones. Additionally, electrical-based approaches and sensors are more suitable for performing the majority of signal processing tasks within the chip.

Currently, in the circumstances that the biomedical samples are tested under electrical-based diagnosis approaches, the sensing devices are fairly bulky and difficult to portability, and therefore some embodiments of the present disclosure provide a semiconductor biosensor diagnostic system that includes a portable diagnostic cartridge that can provide high-quality diagnosis result. In these embodiments, the semiconductor biosensor chip allows direct sensing of the sample material and directly converts the biomedical signal to an electrical signal.

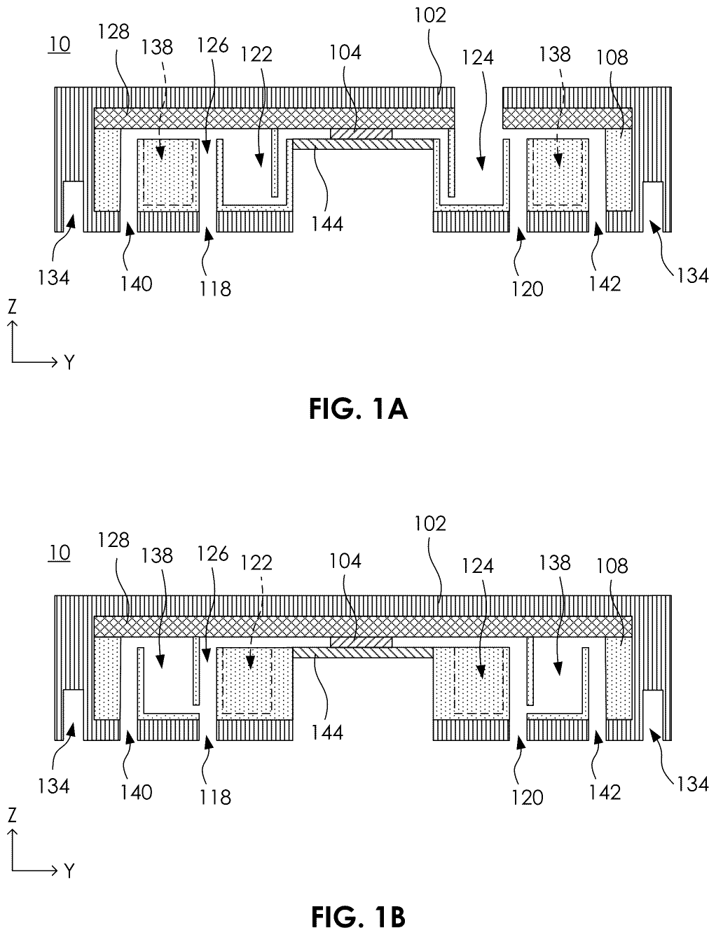

FIGS. 1A and 1B illustrate a diagnostic cartridge 10 according to some embodiments of the present disclosure. FIGS. 1A and 1B are obtained from different cross-sectional lines of the diagnostic cartridge 10, and so that different reservoirs in the diagnostic cartridge 10 can be illustrated in these figures. In some embodiments, from the cross-sectional view perspective shown in FIG. 1, the diagnostic cartridge 10 includes a case body 102, a biosensor device 104, and a fluid-guide body 108. Roughly, the diagnostic cartridge 10 is a portable case that can be used to accommodate biomedical samples and have a function to convert the biomedical signal of the biomedical samples to the electrical signal. Therefore, the arrangement of the chip inside the diagnostic cartridge 10 and planning the flow of the sample are important matters in designing the diagnostic cartridge 10.

In some embodiments, the case body 102 is a hard case used to protect the structures inside the diagnostic cartridge 10. In order to match with the device to read the information from the diagnostic cartridge 10, the case body 102 can include a plurality of openings for communications, which will be described later.

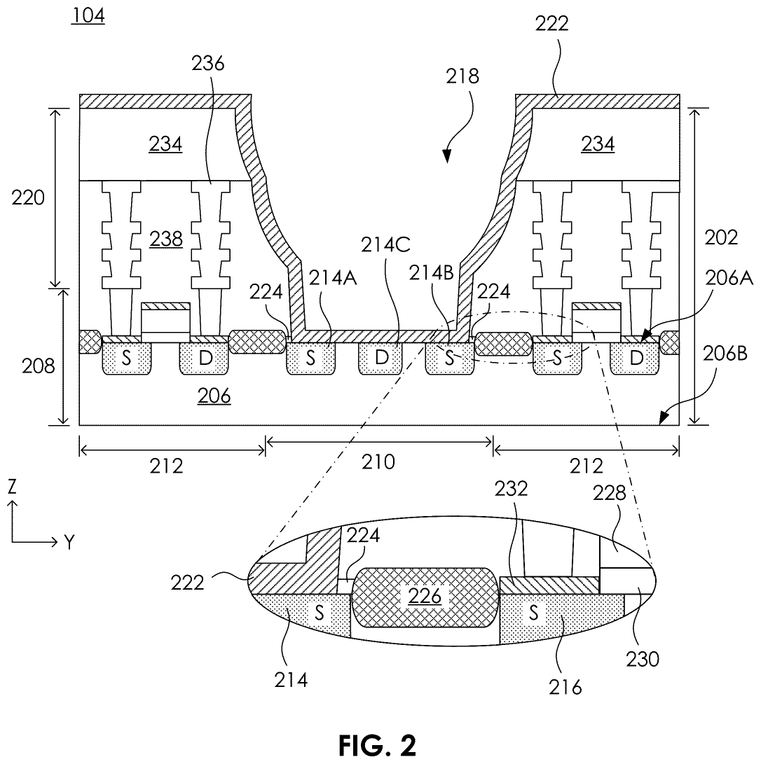

In some embodiments, the biosensor device 104 is disposed in proximity to an inner surface 102A of the case body 102. In some embodiments, the biosensor device 104 is a biosensor chip that can be utilized to allow direct detection of biological analytes and to convert the bio-signal directly to an electrical signal. In some embodiments, the detection and the signal conversion can be performed by a CMOS IC biosensor, a silicon nanowire biosensor, an extended-gate FET biosensor, an ISFET, or the like. In the scenario that a CMOS IC biosensor is applied, the biosensor device 104 may include an integrated biosensor structure and that the sensing structure is directly formed on a CMOS structure, which can make the biosensor perform the features of good sensitivity, and the manufacturing cost thereof is acceptable as well. For instance, referring to the embodiment illustrated in FIG. 2, the biosensor device 104 includes a CMOS structure 202 and a sensing oxide layer 222 formed over the CMOS structure 202. The CMOS structure 202 includes a substrate 206, a front-end-of-line (FEOL) structure 208, and a back-end-of-line (BEOL) structure 220 formed in proximity to a first surface 206A of the substrate 206. In some embodiments, the substrate 206 is a semiconductor substrate made of semiconductor materials such as silicon, germanium, diamond, or the like. Alternatively, in other embodiments, compound materials such as silicon germanium, silicon carbide, gallium arsenic, indium arsenide, indium phosphide, silicon germanium carbide, gallium arsenic phosphide, gallium indium phosphide, combinations thereof, and the like, may also be used to form the substrate 206.

In some embodiments, the substrate 206 includes different regions configured to perform distinct functions. As shown in FIG. 2, in such embodiment, the substrate 206 includes a sensing region 210 and a logic region 212 surrounding the sensing region 210. In the present disclosure, the meanings of these regions can be vertically extended, for example, the structures that formed over the sensing region 210 of the substrate 206 can be identified as “within the sensing region 210”, and so does the logic region 212. The sensing region 210 is configured to form a sample-holding structure for the sensing purpose, whereas the logic region 212 is configured to form an interconnect structure for the electrical purpose. In some embodiments of the present disclosure, the sample-holding structure within the sensing region 210 is substantially leveled with the interconnect structure within the logic region 212. In other words, the path for signal transmission in some embodiments of the present disclosure can be shortened by excluding the interconnect structure from the path between the sample-holding structure and a sensing structure (e.g., a doped region within the sensing region 210). More details are disclosed as follows.

In some embodiments, the FEOL structure 208 can be formed in/on the substrate 206. In some embodiments, the FEOL structure 208 has a plurality of doped regions at the first surface 206A of the substrate 206. In some embodiments, a portion of the doped regions (e.g., the first doped regions 214) are located within the sensing region 210, while another portion of the doped regions (e.g., the second doped regions 216) are located within the logic region 212. In some embodiments, the doped regions located within the sensing region 210 are configured to perform as terminals in receiving or sensing the change of potential (AV) induced by a sensing layer thereon. For example, in the case of the biosensor device 104 in the present disclosure is used for DNA sequencing, particularly, for non-optical DNA sequencing, a DNA template can be accommodated in the sample-holding structure within the sensing region 210. Then, protons (H+) are released when nucleotides (dNTP) are incorporated into the growing DNA strands, changing the pH of the medium in the sample-holding structure (ApH). This progress can induce a change in the surface potential of the sensing layer and a change in the potential (AV) of the source terminal in the substrate 206.

Other than the portion of the doped regions located within the sensing region 210, the doped regions within the logic region 212 are configured to perform the functions of the terminals of field-effect transistors (FET), which means these doped regions can be a portion of the transistors within the logic region 212, and generally, these transistors are connected to the BEOL structure 220 thereover. In some embodiments, the signals acquired from the sensing region 210 can be transmitted to other semiconductor devices (e.g., an amplifier circuit) by the structures in the logic region 212.

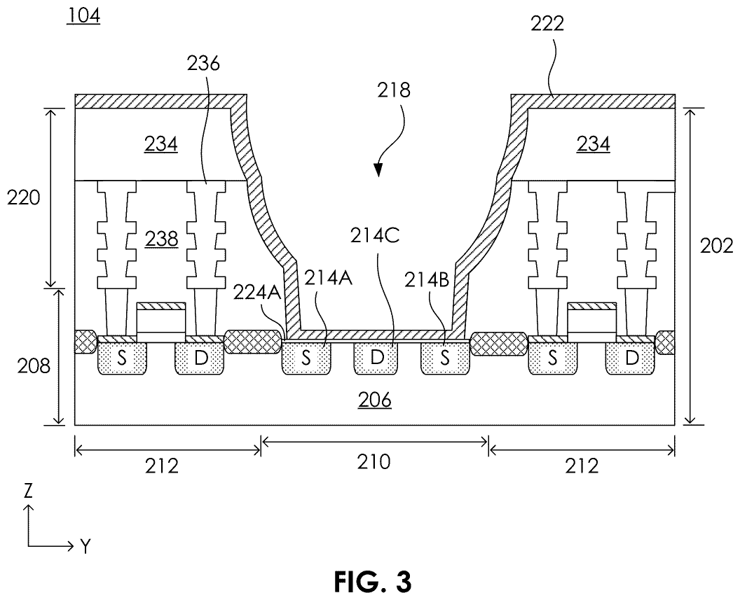

As shown in FIG. 2, in some embodiments, the BEOL structure 220 over the FEOL structure 208 includes a first trench 218 exposing the sensing region 210 of the substrate 206. The first trench 218 can be called a well or a nanowell, depending on the size thereof. In some embodiments, as the example shown in FIG. 3, the doped regions such as the source regions 214A, 214B and the drain region 214C are exposed at a bottom of the first trench 218 (these source/drain regions are exposed in the CMOS structure 202, but the CMOS structure 202 is further be covered by a sensing oxide layer 222, which will be discussed later). In some embodiments, the bottom of the first trench 218 is substantially identical to or coplanar with the first surface 206A of the substrate 206.

In other embodiments, as shown in FIG. 3, each of the doped regions within the sensing region 210 such as the source regions 214A, 214B, and the drain region 214C are not entirely exposed at the bottom of the first trench 218 due to the coverage of a thin first gate oxide 224A. The first gate oxide is a gate dielectric layer of a gate structure, which is formed under a gate electrode of the gate structure. The gate dielectric layer may be made of silicon oxide, silicon nitride, or a high dielectric constant material (high-k material). In some embodiments, the gate dielectric layer is formed by a chemical vapor deposition (CVD) operation. In some embodiments of the present disclosure, the gate dielectric layer is made of silicon oxide, thus called gate oxide hereinafter.

The gate electrode that formed over the gate oxide may be made of polysilicon (POLY) or any other suitable conductive material. The suitable conductive material includes but is not limited to metal (e.g., tantalum, titanium, molybdenum, tungsten, platinum, aluminum, hafnium, ruthenium), metal silicide (e.g., titanium silicide, cobalt silicide, nickel silicide, tantalum silicide), or metal nitride (e.g., titanium nitride, tantalum nitride). In some embodiments, the gate electrode is formed by chemical vapor deposition (CVD), low-pressure chemical vapor deposition, physical vapor deposition (PVD), atomic layer deposition, or spin-on. In some embodiments, the gate structure is formed by forming the gate electrode on the gate oxide, and then patterning the gate electrode by etching to form the gate structure. In some embodiments of the present disclosure, the first gate oxide 224 is thinned down after a removing operation to a polysilicon gate electrode formed thereon, and such thin first gate oxide 224A can be used as an etch stop layer in removing the poly gate electrode to protect the intactness of the doped regions there below within the sensing region 210. In some embodiments, the first gate oxide 224 can be removed in the operation of forming the first trench 218 prior to forming a sensing oxide layer 222 thereon.

In some embodiments, a portion of the first gate oxide 224 can be removed in the operation of forming the first trench 218 prior to forming the sensing oxide layer 222 thereon, while another portion of the first gate oxide 224, or called a first gate oxide residue, is adjacent to an edge of the first trench 218, particularly, as shown in the enlarged portion in FIG. 2. In some embodiments, a side of the first gate oxide (residue) 224 is exposed at a corner portion of the first trench 218 to be in contact with the sensing oxide layer 222. That is, in order to well protect the doped regions within the sensing region 210 during the manufacturing process, the boundary of the first trench 218 can land over the doped region within the sensing region 210, and therefore the first gate oxide 224 is partially removed, and the first gate oxide residue is left near the edge of the sensing region 210.

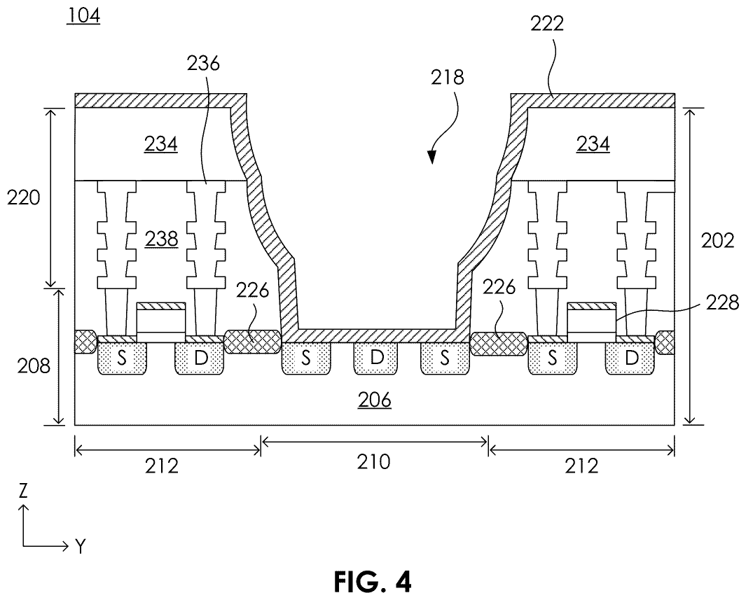

In other embodiments, as shown in FIG. 4, the edge of the first trench 218 is aligned with an edge of a field oxide 226, and therefore the first gate oxide 224 can be removed entirely in the operation of forming the first trench 218.

As shown in FIGS. 2-4, the structure features within the logic region 212 can be the same. In some embodiments, a plurality of poly gate structures 228 are formed over the doped regions within the logic region 212. In some embodiments, a second gate oxide 230 can be formed between the first surface 206A of the substrate 206 and each of the plurality of poly gate structures 228. In some embodiments, each of the plurality of poly gate structures 228 and a least a portion of each of the doped regions within the logic region 212 are covered by a silicide layer 232. In some embodiments, there are at least two second gate oxides 230 over the logic region 212 of the substrate 206, the two second gate oxides 230 are located at two sides of the first trench 218, respectively.

In some embodiments, the sensing oxide layer 222 is formed over the BEOL structure 220 and in contact with the first surface 206A within the sensing region 210 of the substrate 206. That is, the sensing oxide layer 222 can be formed over the BEOL structure 220 within the logic region 212, while the first trench 218 is formed within the sensing region 210, the structure of the sensing oxide layer 222 is conformal with the profile of first trench 218 to form a sensing trench within the sensing region 210. In some embodiments, the sensing oxide layer 222 includes hafnium oxide (HfOₓ). In some embodiments, the thickness of the sensing oxide layer 222 is about 3 nm. In some embodiments, since the inner sidewall of the first trench 218 does not include a continuous planar profile due to an altar of the etching operation in forming the first trench 218, the profile of the sensing oxide layer 222 in the first trench 218 includes at least a change of slope along the inner sidewall of the first trench 218.

In some embodiments, the silicide layer 232 is not formed within the sensing region 210, thus each of the doped regions free from in contact with the sensing oxide layer 222 is covered by a silicide layer 232. That is, silicide is a compound of silicon with metal, and therefore the silicide layer 232 can ensure low contact and series resistance to the source and drain region of the transistor within the logic region 212, whereas the doped regions within the sensing region 210 (i.e., the first doped regions 214) do not need to have conductive contacts and metallization structures thereon, hence there is no silicide layer 232 formed within the sensing region 210.

In some embodiments, within the logic region 212, a metallization structure 236 is formed over the plurality of poly gate structures 228 and the plurality of second doped regions 216. The metal layers and conductive contacts and vias in the metallization structure 236 can be surrounded by an interlayer dielectric (ILD) 238. In some embodiments, since the silicide layer 232 is formed to cover the plurality of poly gate structures 228 and the second doped regions 216 within the logic region 212, the conductive contacts of the metallization structure 236 can be landed on the top surface of the silicide layer 232. In some embodiments, the metallization structure 236 includes four metal layers connected by a plurality of conductive vias therebetween, however, the number of the metal layers is not a limitation of the present embodiments.

In some embodiments, the logic region 212 includes a passivation layer 234 formed over the metallization structure 236. The passivation layer 234 may be made of undoped silicate glass (USG), silicon oxynitride, phosphosilicate glass (PSG), borophosphosilicate glass (BPSG), fluorinated silicate glass (FSG), organosilicate glasses (OSG), SiOₓC_{y}, Spin-On-Glass, or the like. In some embodiments, the passivation layer 234 is formed by high density plasma (HDP), chemical vapor deposition (CVD), plasma-enhanced CVD, sputter, spin-on, physical vapor deposition (PVD), or other applicable methods.

In some embodiments, the sensing oxide layer 222 as previously mentioned can be formed over the passivation layer 234. In some embodiments, the sensing oxide layer 222 is in contact with the passivation layer 234. In some embodiments, the sensing oxide layer 222 in the sensing region 210 extends to the logic region 212 along a side of the metallization structure 236 and a side of the passivation layer 234. In some embodiments, the slope of the side of the first trench 218 (or the slope of the sensing oxide layer 222) is changed due to a change in the etching operations. For example, in forming the first trench 218 that penetrates the passivation layer 234 and the metallization structure 236, an isotropic etching operation can be applied at the very beginning in etching the passivation layer 234 and a portion of the metallization structure 236, and then an anisotropic etching operation can be applied to etch the remained metallization structure 236 to expose the first surface 206A of the substrate 206 within the sensing region 210.

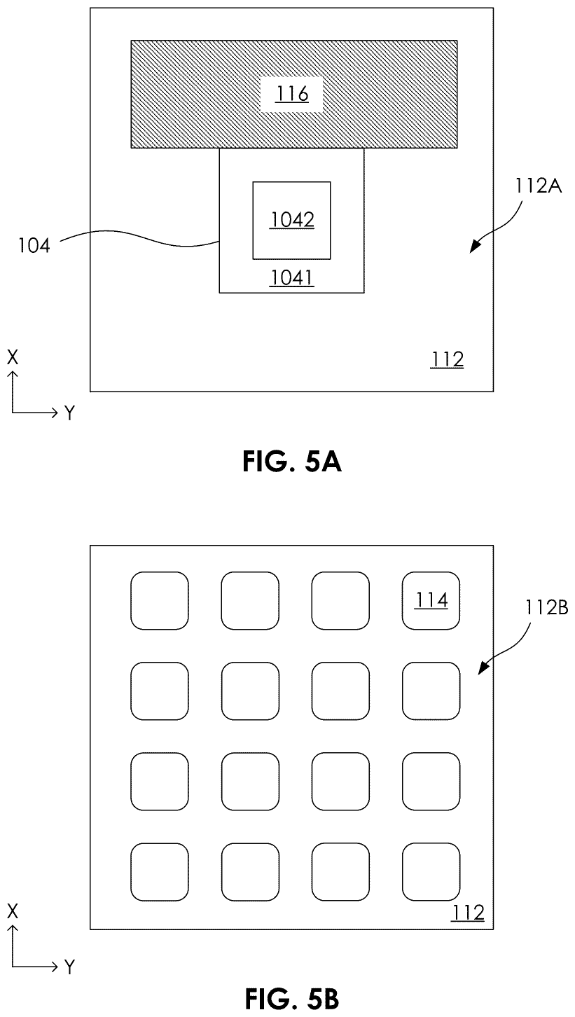

In order to integrate the biosensor device 104 into the diagnostic cartridge 10, in some embodiments, the biosensor device 104 is disposed on a substrate such as a semiconductor substrate, an ITO glass substrate, a metal substrate, a printed circuit board (PCB), a flexible print circuit (FPC) substate, an interposer, a wiring substrate, or the like. The PCB 112, for example, can be disposed on the inner surface 102A of the case body 102. The PCB 112 has an upper surface 112A and a lower surface 112B opposite to the upper surface 112A. Referring to FIGS. 5A and 5B, which illustrate different sides of the PCB 112, in some embodiments, the PCB 112 includes a plurality of metal pads 114 (or called a metal pad structure) at the lower surface 112B, the metal pads 114 are electrically connected to the biosensor device 104 on the upper surface 112A through a plurality of wiring portions passing through the PCB 112. Other than the ordinary PCB, in other embodiments, the biosensor device 104 can be mounted over a substrate which is optical transmissible for reading optical signal if the biosensor device 104 is designed to provide them.

In some embodiments, the size of the biosensor device 104 is as small as a few millimeters square, for instance, both the wide and length of the biosensor device 104 can be about 4.5 mm, while a sensing region 1042 of the biosensor device 104 is only about 3.2*3.2 mm². In some embodiments, the sensing region 1042 is surrounded by a containment structure 1041 to assist in concentrating the sample in the sensing region 1042; in such embodiments, the containment structure 1041 can be a portion of the fluid-guide body 108, and the containment structure 1041 can include several holes for the pass of liquid (i.e., the channels, which will be described later).

In some embodiment, the wiring portion at the upper surface 112A of the PCB 112 is covered by an epoxy material 116 for preventing oxidation. In some embodiments, the metal pads 114 at the lower surface 112B of the PCB 112 are arranged in an array, while such array is arranged for corresponding to a probe structure to read the electrical signal from the biosensor device 104. The probe structure will be further described later.

In some embodiments, the detection and the signal conversion can be performed by a biosensor die that free of being packaged. For instance, the biosensor die may electrically connect to a package substrate through a plurality of conductive pads thereof and a plurality of metal wires. The material package substrate may be a semiconductor substrate, an ITO glass substrate, a PCB, a flexible printed circuit (FPC) board, etc.

In some embodiments, the biosensor device 104 can take the form of a biology slide, incorporating a bioarray structure. This bioarray structure, which may be referred to as a bioarray chip or microarray, is a miniaturized biological experimental platform typically composed of a microarray. In some embodiments, it consists of an array of biological molecules such as DNA, RNA, proteins, or cells, immobilized in a highly ordered fashion on the biology slide.

Optionally, in some embodiments, an elastic membrane or film can be disposed at a side of the case body 102. In some embodiments, the elastic membrane is made of polydimethylsiloxane (PDMS). The elastic membrane can be used for sealing the opening of in the fluid-guide body 108, and while the diagnostic cartridge 10 is in the course of sample analysis, the elastic membrane can be punctured to pump the fluid such as air or liquid through the openings.

The openings and the reservoirs are provided by the fluid-guide body 108, configured to guide a sample and a buffer liquid to the biosensor device 104. In some embodiments, the fluid-guide body 108 is disposed over the clastic membrane. In some embodiments, the material of the fluid-guide body 108 includes plastic. In some embodiments, the material of the fluid-guide body 108 includes polymer. In some embodiments, the fluid-guide body 108 can be made by CNC, casting, molding, 3D printing, or the like. In some embodiments, the openings and the reservoirs provided by the fluid-guide body 108 includes, for instance, a first pumping opening 118 and a second pumping opening 120 are configured to drive the fluid flow in the fluid-guide body 108 due to fluid pressure difference, and a buffer reservoir 122 and a sample reservoir 124 are configured to accommodate buffer liquids and biomedical samples. In some embodiments, referring to the cross-sectional view perspective shown in FIG. 1A, the first pumping opening 118 is in proximity to a first side 1081 of the fluid-guide body 108, the second pumping opening 120 is in proximity to a second side 1082 of the fluid-guide body 108 opposite to the first side 1081. In addition, the buffer reservoir 122 and the sample reservoir 124 are laterally between the first pumping opening 118 and the second pumping opening 120. The fluid-guide body 108 further includes a plurality of channels 126 configured to connect the first pumping opening 118, the second pumping opening 120, the buffer reservoir 122, and the sample reservoir 124; and therefore, the liquid in the buffer reservoir 122 and the sample reservoir 124 can be drove along the channels 126 by pumping the air from the first pumping opening 118 and the second pumping opening 120. In some embodiments, each of the buffer reservoir 122 and the sample reservoir 124 is connected to at least two of the plurality of channels 126 so that the fluid may passing through the buffer reservoir 122 and the sample reservoir 124.

In some embodiments, although the plurality of channels 126 in the diagnostic cartridge 10 are substantially connected among the reservoirs, these channels 126 can be defined to include a first loop comprising the first pumping opening 118 and the buffer reservoir 122, and a second loop comprising the second pumping opening 120 and the sample reservoir 124, wherein the first loop and the second loop sharing a common channel passing through the biosensor device 104. In some embodiments, the feature of the present disclosure is to ensure that these loops, which is primary for the passing of the biomedical sample 40 and the buffer liquid 42, respectively, can be overlapped at the position of the biosensor device 104 to ensure the biosensor device 104 may in contact with the biomedical sample 40 and the buffer liquid 42 alternatively.

Referring to FIG. 1B, in some embodiments, the fluid-guide body 108 further includes a plurality of waste reservoirs 138 adjacent to the sample reservoir 124 and the buffer reservoir 122, respectively. The waste reservoirs 138 are configured to accommodate the used sample liquid or the used buffer liquid from the sample reservoir 124 and the buffer reservoir 122, respectively. In order to receive the used sample liquid or the used buffer liquid, the waste reservoirs 138 are connected to the channels connecting with the sample reservoir 124 and the buffer reservoir 122.

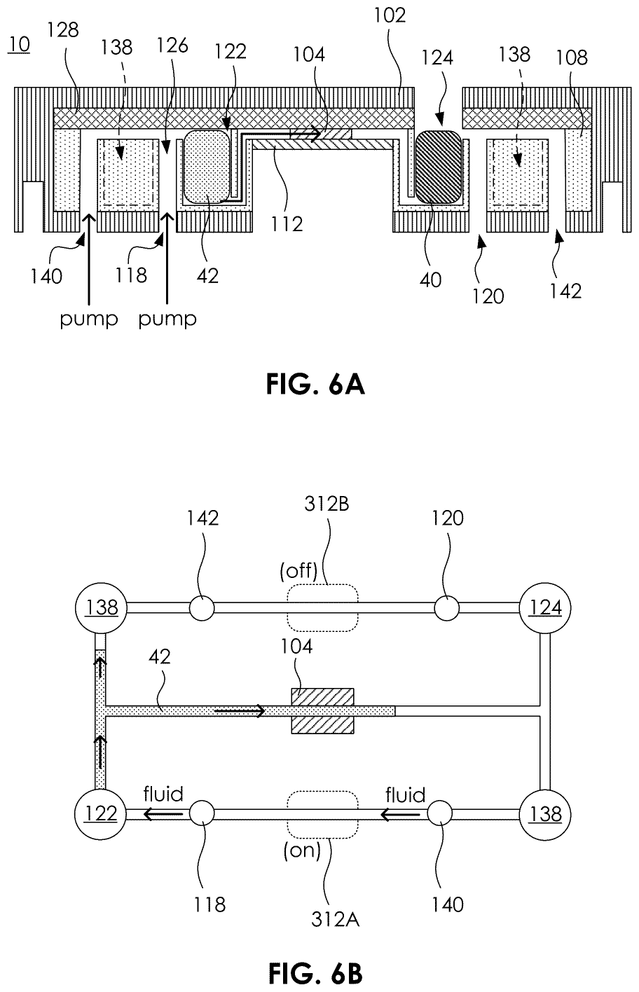

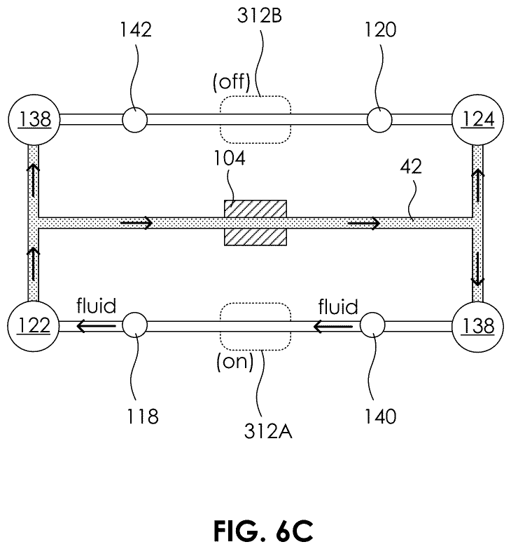

That is, referring to FIGS. 6A and 6B, in some embodiments, in the scenario that the fluid is pumped into the channels 126 from the first pumping opening 118 and/or the third pumping opening 140 through a micro pump 312A connecting to the first pumping opening 118 and the third pumping opening 140, the liquid in the buffer reservoir 122 (e.g., the buffer liquid 42) would be moved toward the position of the biosensor device 104 along the channel 126 between the buffer reservoir 122 and the position of the biosensor device 104 (see the arrows along the channel 126 in FIG. 6B). Since the channel 126 has passed through the biosensor device 104, the buffer liquid 42 can thus in contact with the biosensor device 104 (e.g., in contact with the sensing oxide layer 222 shown in FIGS. 2-4) to clean or to pretreating the biosensor device 104 prior to the sample sensing operation. In some embodiments, the buffer liquid 42 includes phosphate buffered saline (PBS). Other than the buffer liquid 42 passed through the biosensor device 104, in some embodiments, some of the buffer liquid 42 would be moved toward one of the waste reservoirs 138 directly based on the direct connection between such waste reservoir 138 and the buffer reservoir 122 through the channel 126.

After the biosensor device 104 is washed accordingly, in some embodiments, referring to FIG. 6C, the buffer liquid 42 utilized to clean or pretreating the biosensor device 104 can be further moved toward at least one of the waste reservoirs 138 by continuing to pump fluid into the channels 126 from either the first pumping opening 118 or the third pumping opening 140, since more buffer liquid 42 would be pushed out from the buffer reservoir 122 by the fluid. In other embodiments, the movement of the buffer liquid 42 in the channels 126 relies on the suction of fluid. That is, either the first pumping opening 118 or the third pumping opening 140 can be used to evacuate the fluid from the channels 126 using the micro pump 312A. In other words, the movement of the buffer liquid 42 in the channels 126 can be driven by the movement of the fluid pumped by the micro pump 312A, while the selection of the mode of pumping fluid into the channels or out of the channels depends on the arrangement of the reservoirs in the diagnostic cartridge.

In some embodiments, a reference electrical signal (e.g., a reference voltage, a reference current, etc.) can be obtained when the biosensor device 104 is washing by the buffer liquid 42. The reference electrical signal can be seen as a base value that may be used to compare with the electrical signal that obtained after the biosensor device 104 is interacted with the biomedical sample 40.

In some embodiments, some of the buffer liquid 42 may be moved toward the sample reservoir 124 after passing through the biosensor device 104 based on the connection between such sample reservoir 124 and the position of the biosensor device 104 through the channel 126. Generally, the buffer liquid 42 may be controlled as waived from substantially entering the sample reservoir 124 by the length of the channel 126 between the sample reservoir 124 and the position of the biosensor device 104. For example, the buffer liquid 42 would preferentially enter the waste reservoir 138 nearby instead of the sample reservoir 124.

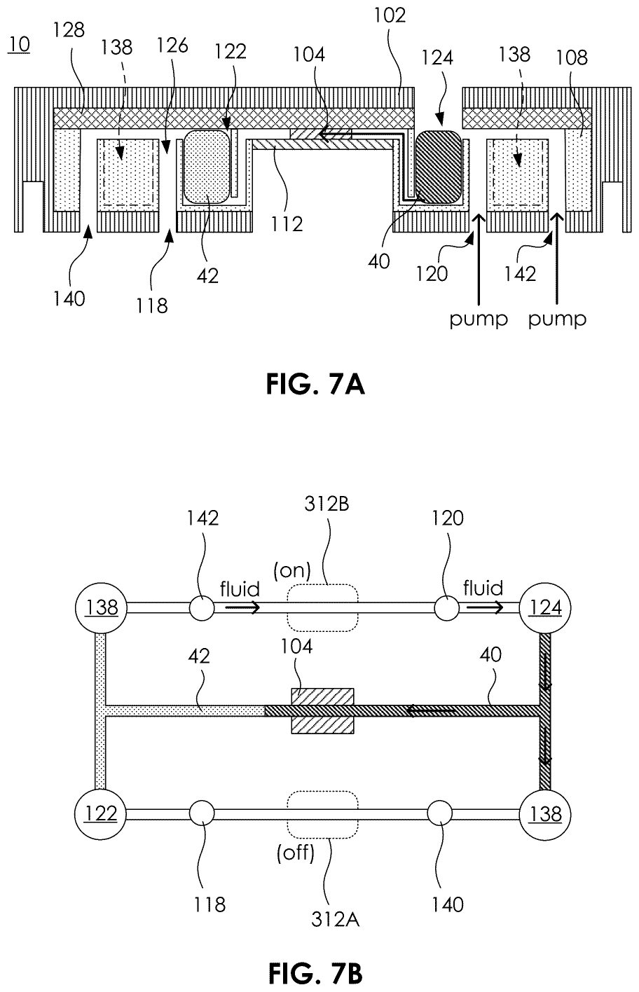

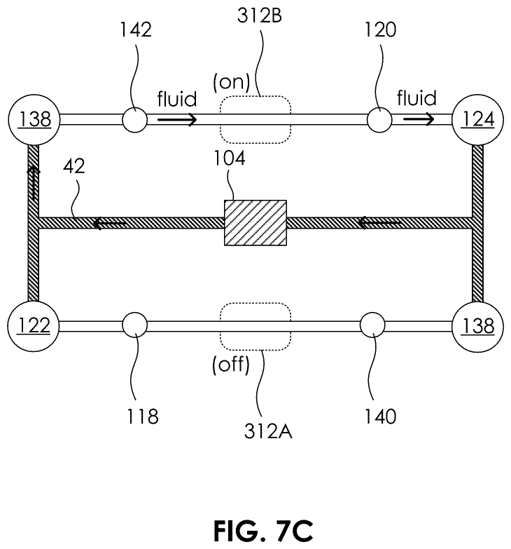

Referring to FIGS. 7A and 7B, in some embodiments, after the biosensor device 104 is washed and ready to be used to sensing the sample, the fluid can be pumped into the channels 126 from the second pumping opening 120 and/or the fourth pumping opening 142 through another micro pump 312B connecting to the second pumping opening 120 and the fourth pumping opening 142. The liquid in the sample reservoir 124 (e.g., the biomedical sample 40) would be moved toward the position of the biosensor device 104 along the channel 126 between the sample reservoir 124 and the position of the biosensor device 104 (see the arrows along the channel 126 in FIG. 7B). Again, since the channel 126 has passed through the biosensor device 104, the biomedical sample 40 can thus in contact with the biosensor device 104 (e.g., in contact with the sensing oxide layer 222 shown in FIGS. 2-4), and a sensing information can be obtained from the biosensor device 104. In some embodiments, the sensing information can be a sample electrical signal (e.g., a sample voltage, a sample current, etc.) that use to compare with the reference electrical signal to obtain the change of the voltage, current, etc. In some embodiments, the sample electrical signal can be obtained from the charges generated during the bonding of the sample molecules to the biosensor device 104 in the pretreatment operation. In some embodiments, since the channels 126 are filled or occupied by the buffer liquid 42 in the previous process for obtaining the reference electrical signal, the biomedical sample 40 from the sample reservoir 124 may displace the buffer liquid 42 when the biomedical sample 40 is moving toward the position of the biosensor device 104. Accordingly, in some embodiments, an interface of the buffer liquid 42 and the biomedical sample 40 may pass through the position of the biosensor device 104 during the displacement process. Next, referring to FIG. 7C, after the sensing information is obtained, the biomedical sample 40 can be further moved toward at least one of the waste reservoirs 138 by continuing to pump fluid into the channels 126 from either the second pumping opening 120 or the fourth pumping opening 142.

As the examples shown in FIGS. 6A to 7C, the operation of the diagnostic cartridge can be substantially divided into two fluid loops: one for the buffer liquid 42 and the other for the biomedical sample 40. In some embodiments, these two loops are structurally independent from each other, except for sharing a primary, common channel that passes through the biosensor device 104.

In some embodiments, each of the plurality of channels 126 along the path between the sample reservoir 124 and the buffer reservoir 122 comprises a plurality of U-turn structures. These U-turn structures are configured to control the flow speed of either the biomedical sample 40 or the buffer liquid 42. In other embodiments, if the micro pump drives the liquid flow at a slow speed, the design of channels 126 with a large number of U-turn structures can be omitted.

In other embodiments, the control of the flow speed of either the biomedical sample 40 or the buffer liquid 42 can also be performed by the design and the arrangement of the plurality of channels 126 with varied sizes, other than the aspect of the shape (e.g., the U-turn structures) of the plurality of channels 126.

By selecting the openings of the fluid-guide body to be pumped, the flow of the buffer liquid 42 and the biomedical sample 40 can be well-controlled. In some examples, the first pumping opening 118 can be pumped first to push the buffer liquid 42 along the channel 126 using the fluid, thus the sensing oxide layer 222 of the biosensor device 104, for example, can be cleaned or pretreated by the buffer liquid 42, and an initial electrical data (e.g., the reference electrical signal) can be measured; next, the biomedical sample 40 can be injected into the sample reservoir 124 (or can be injected into the sample reservoir 124 before the aforementioned cleaning/pretreating operation); and then the second pumping opening 120 can be pumped to guide the biomedical sample 40 to the first trench 218 of the biosensor device 104 along the channel 126 using the fluid to make the biomedical sample 40 in contact with the biosensor device 104 (e.g., in contact with the sensing oxide layer 222). After the biomedical sample 40 interacts with the biosensor device 104, a final electrical data (e.g., the sample electrical signal) can be measured and compared with the initial electrical data to acquire a difference value that refers to the precise result of the reaction between the biomedical sample and the biosensor device 104. In some embodiments, the result is based on the change of potential value and can be transformed into the current change of the transistors. In other embodiments, the change of current can be obtained directly. On the other hand, since the biosensor device 104 includes transistor structures (transistor-based device), compared with some comparative embodiments that use nanowires (resistor-based device) as sensing structure, the electrical signal in some embodiment of the present disclosure can be amplified by the analog circuits in the biosensor device 104 to obtain a clear electrical signal after gain without being covered by noise, while the resistance of the nanowires in the comparative embodiments is hard to be precisely designed, and the weak current (e.g. several nA) passing through the nanowires would have a poor signal-to-noise ratio (SNR). Accordingly, in the scenario that the dosage of the biomedical sample 40 is low, the biosensor device 104 in the present disclosure is still applicable to detect the target ingredient. In some embodiments, before reading the electrical signal from the biosensor device 104, the fluid can be pumped to push the buffer liquid 42 from the buffer reservoir 122 into the channels 126 again to push the buffer liquid 42 toward the position of the biosensor device 104. This process may wash away unbonded residues on the biosensor device 104. Then, the electrical signal can be read and obtained in an accurate manner.

Generally, it is possible that a portion of the buffer liquid 42 can flow into the channels 126, particularly those in proximity to the sample reservoir 124 when pumping through the first pumping opening 118. However, the amount of this buffer liquid 42 is limited and would not enter the sample reservoir 124 under the design of the channels 126 and the control of pumping, and therefore the effect of such portion can be neglected. Likewise, a portion of the biomedical sample 40 can flow into the channels 126, particularly those in proximity to the buffer reservoir 122 when pumping through the second pumping opening 120, the movement of this biomedical sample 40 is also negligible.

In some embodiments, the diameter of the channel 126 is no greater than about 100 μm. In some embodiments, the diameter of the channel 126 is no greater than about 50 μm. In some embodiments, the diameter of the channel 126 is no greater than about 20 μm. In some embodiments, the diameter the channel 126 is no greater than a threshold that the liquid (e.g., the biomedical sample 40 or the buffer liquid 42) can perform self-flowing in the channel 126. In other words, since the diameter of the channel 126 is small in some embodiments of the present disclosure, the liquid in the channel 126 cannot perform self-flowing, hence the liquid can only be driven by the pumping operations.

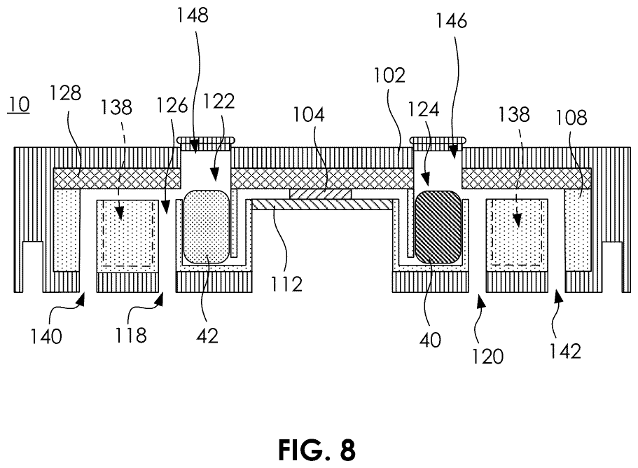

As previously mentioned, the biomedical sample 40 can be injected into the sample reservoir 124 before the cleaning/pretreating operation, and the case body 102 may have a first opening 146 with a first cover set over the sample reservoir 124 for injecting or loading the biomedical sample 40. Likewise, referring to FIG. 8, in some embodiments, the case body 102 may include a second opening 148 with a second cover set over the buffer reservoir 122 configured to inject or load the buffer liquid 42. In those embodiments, the user may load the buffer liquid themselves instead of having it loaded when manufacturing the diagnostic cartridge by the producer.

In some embodiments, the biomedical sample 40 and/or the buffer liquid 42 can be collected in small bottles or similar container units before being loaded into the sample reservoir 124 and the buffer reservoir 122, respectively. In some embodiments, these kinds of container units can be plugged into the locations of the sample reservoir 124 and the buffer reservoir 122, where the sample reservoir 124 and the buffer reservoir 122 can be designed to have a receiving structure to couple with the container units and allow the biomedical sample 40 and the buffer liquid 42 in the container units to move into the channels 126 of the diagnostic cartridge 10. For instance, several micro needles can be disposed in the reservoirs for piercing the container units. By using the container units and this pre-collection manner, some users may provide the biomedical sample in a more convenient way since the cost of the container units (e.g., the manufacture or delivery) may be substantially lower than that of the diagnostic cartridge, or the container units can be integrated with the sampling device.

In some embodiments, the cover body 110 is disposed over the case body 102 and covers the fluid-guide body 108. In some embodiments, the material of the cover body 110 is identical to that of the cover body 110. The functional components such as the biosensor device 104, the clastic membrane 106, the fluid-guide body 108 can be well-protected by the combination of the case body 102 and the cover body 110. In some embodiments, the shield structure of the diagnostic cartridge 10 is at least separated into the body 102 and the cover body 110 because of the manufacturing process requirement, while the mechanism that how to combine these two parts do not affect the diagnosis function of the diagnostic cartridge 10.

In some embodiments, the diagnostic cartridge 10 further includes a scaling membrane 128 disposed over the fluid-guide body 108. The sealing membrane 128 can be an adhesive tape configured to be adhesive in proximity to a side of the fluid-guide body 108. In some embodiments, the scaling membrane 128 is a pressure sensitive tape. In some embodiments, the material of the scaling membrane 128 includes PDMS. That is, the stack of the elastic membrane 106, the fluid-guide body 108, and the scaling membrane 128 can be a three-layer-PDMS-sheet design that even though the material is substantially identical, being manufactured separately is much easier to form the microstructures thereof. For instance, the channels and reservoirs in the diagnostic cartridge 10 can be formed by engraving the surfaces of the PDMS sheet before attaching them to each other. The sealing membrane 128 is configured to seal the buffer reservoir 122 and the sample reservoir 124, so that the leakage of the buffer liquid from the buffer reservoir 122 before using the diagnostic cartridge 10 can be avoided. Meanwhile, the scaling membrane 128 can be used to avoid contamination of the sample reservoir 124, such as some unwanted environmental substances. In some embodiments, the sealing membrane 128 can be punctured to inject the biomedical sample into the sample reservoir 124.

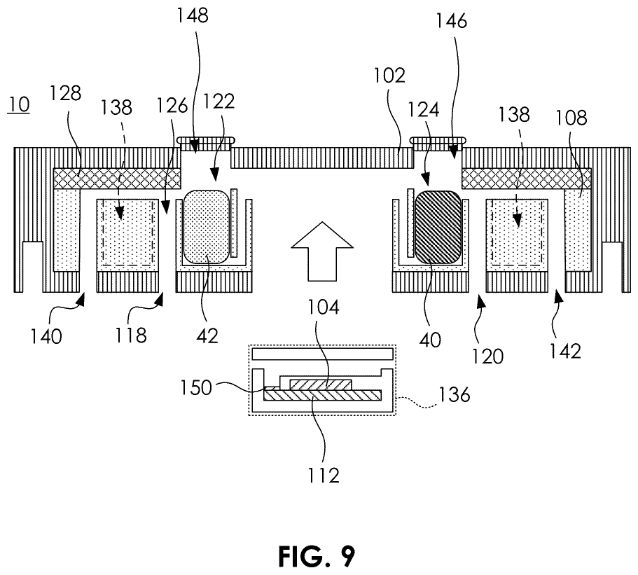

Referring to FIG. 9, in some embodiments, the biosensor device 104 is packaged in an embedding module 136, and the embedding module 136 is detachable from the case body 102. In some embodiments, within the embedding module 136, the biosensor device 104 and the PCB 112 (or other kinds of substrates) mounted there below are both packaged in a case material of the embedding module 136, while a sensing structure 150 over the PCB 112 is exposed to interact with the buffer liquid 42 and the biomedical sample 40. The sensing structure 150 is electrically connected with the biosensor device 104 through the PCB 112.

In order to read the electrical signal from the diagnostic cartridge 10 speedy in a convenient manner, in some embodiments of the present disclosure, the semiconductor biosensor diagnostic system includes a cartridge diagnostic base 30 configured to diagnose the sample in the diagnostic cartridge 10. Particularly, the design rule of the cartridge diagnostic base 30 is corresponding to the structure of diagnostic cartridge 10.

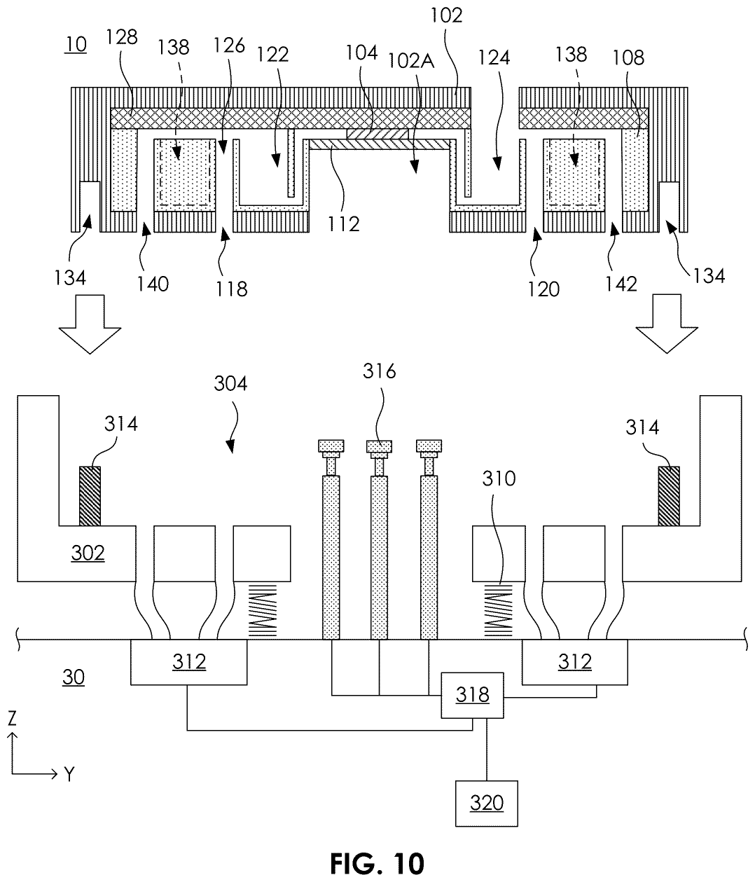

Referring to FIG. 10, in some embodiments, the semiconductor biosensor diagnostic system includes the diagnostic cartridge 10 substantially identical to the embodiment previously shown in FIG. 1, for example, and once the diagnostic cartridge 10 has been applied the biomedical sample thereto, it can be placed on the cartridge diagnostic base 30 to read the electrical signal provided by the biosensor device 104. In some embodiments, the cartridge diagnostic base 30 includes a cartridge carrier 302 which has a socket space 304 for placing the diagnostic cartridge 10.

In some embodiments, the cartridge diagnostic base 30 further includes a probe structure 316 facing toward the upper side of the cartridge diagnostic base 30 to in contact with the diagnostic cartridge 10. In some embodiments, the cartridge diagnostic base 30 further includes a plurality of openings at the socket space 304 configured to provide a coupling between the plurality of pumping openings of the diagnostic cartridge and the plurality of micro pumps 312 (e.g., the micro pumps 312A and 312B in previously shown embodiments). In some embodiments, each of the plurality of openings at the socket space 304 includes silicon rubber for the landing of the diagnostic cartridge 10, and may provide a substantial sealed gas connection pathway along the coupling of the openings at the socket space 304 and the pumping openings at the diagnostic cartridge 10. Furthermore, the cartridge diagnostic base 30 may include a spring mechanism 310 under the cartridge carrier 302, which is configured to apply a spring load toward a bottom of the cartridge diagnostic base 30 when placing the diagnostic cartridge 10 in the cartridge carrier 302.

That is, while placing the diagnostic cartridge 10 in the socket space 304 of the cartridge carrier 302, the diagnostic cartridge 10 would be pushed toward the cartridge carrier 302 and the bottom side of the diagnostic cartridge 10 would first in contact with the inner surface of the socket space 304 and make the openings at the socket space 304 coupling with the pumping openings at the diagnostic cartridge 10. In some embodiments, as shown in FIG. 10, the case body 102 includes four pumping openings connecting with the reservoirs in the diagnostic cartridge 10.

In some embodiments, the cartridge diagnostic base 30 includes the plurality of micro pumps 312. In some embodiments, the plurality of openings at the socket space 304 are connected to the micro pumps 312, respectively, so that the fluid and pass through the connection of the openings and the pumping openings for pushing the buffer liquid 42 and the biomedical sample 40 in the diagnostic cartridge 10. In some embodiments, the cartridge diagnostic base 30 includes a microcomputer configured to control the micro pumps 312. In some embodiments, the micro pump 312 can be a motor installed in the cartridge diagnostic base 30.

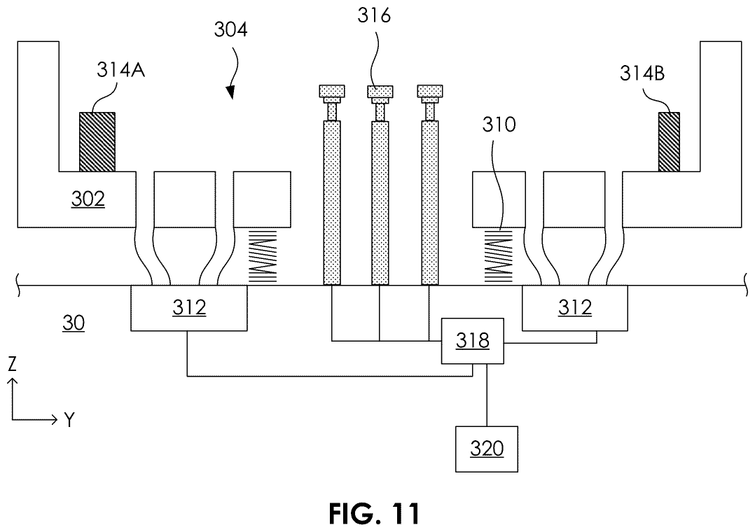

Still referring to FIG. 10, in some embodiments, the cartridge diagnostic base 30 further includes at least two alignment pillars 314, and the diagnostic cartridge 10 includes at least two alignment trenches 134 corresponding to the alignment pillars 314, respectively. The combination of the alignment pillars 314 and the alignment trenches 134 can be used to ensure the position of the diagnostic cartridge 10 landed in the socket space 304 is correct. In some embodiments, each alignment pillar 314 has an identical profile. In some embodiments, the distribution of the alignment pillars 314 in the socket space 304 is arranged to ensure the diagnostic cartridge 10 can be placed in a correct, fixed direction. For example, the alignment pillars 314 can be located asymmetrically to the center of the socket space 304 from a cross-sectional view perspective. In some embodiments, the profiles of the alignment pillars 314 can be different from each other, which is another approach to ensure the direction of the diagnostic cartridge 10 to be placed (scc the alignment pillars 314A and 314B in FIG. 11 as an example).

As previously mentioned, the cartridge diagnostic base 30 includes a probe structure 316 facing toward the upper side of the cartridge diagnostic base 30. In some embodiments, the probe structure 316 includes a plurality of probing pins configured to electrically contact the plurality of metal pads at the lower surface of the PCB 112. In some embodiments, the probing pins are pogo pins. In the scenario that other kinds of substrate is applied, the form and the design of the probe structure 316 would be corresponding to such kinds of substrate accordingly, in order to read the electrical/optical signals properly. In some embodiments, by using the probe structure 316, the electrical signal generated by the biosensor device 104 can be digitally transmitted to a microcomputer connected with the probe structure 316 for further analysis or be displayed by screens.

In order to provide the digital communication as abovementioned, in some embodiments, the probe structure 316 can penetrate the recess 102A of the case body 102 of the diagnostic cartridge 10 to electrically connect to the biosensor device 104. In some embodiments, since the biosensor device 104 is disposed on the PCB 112, the metal pads 114 at the lower surface 112A of the PCB 112 can be exposed from the recess 102A of the case body 102 and in contact with the probe structure 316 when the diagnostic cartridge 10 is placed in the cartridge diagnostic base 30.

In some embodiments, as shown in FIG. 10, the cartridge diagnostic base 30 can be a fully functional compact device that not only includes the components to receive the electrical signal from the diagnostic cartridge 10, but also includes a computing unit 318 and a display unit 320 to illustrate the information regarding the diagnosis result in real-time. In some embodiments, the display unit 320 is a touch screen, and so after the diagnostic cartridge 10 is correctly plugged, installed, or delivered into the cartridge diagnostic base 30, users can control the process of diagnosis through the display unit 320. In other embodiments, the display unit 320 can be omitted and the information can be shown in a remote device that is wired or wirelessly connected to the cartridge diagnostic base 30.

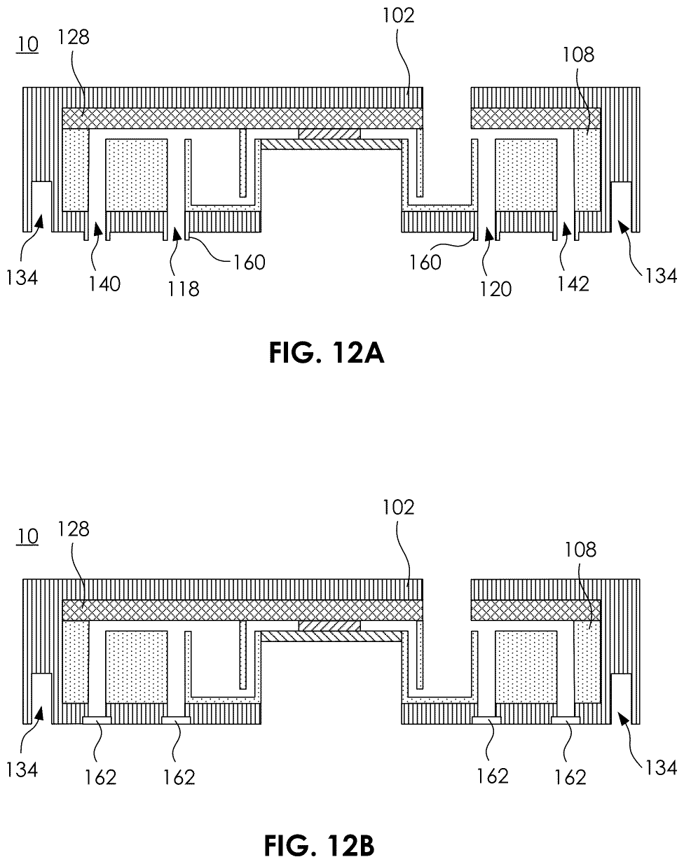

Referring to FIGS. 12A and 12B, in some embodiments, the pumping openings of the diagnostic cartridge 10 may have a structural design for coupling with the micro pumps 312 of the cartridge diagnostic base 30. For instance, in a pin-type design shown in FIG. 12A, each pumping opening of the diagnostic cartridge 10 may include a protrusion structure 160, which acts as a pin structure during coupling with the openings on the cartridge diagnostic base 30, such as being plugged into the silicon rubber at each of the openings within the socket space 304 of the cartridge diagnostic base 30 for securing the diagnostic cartridge 10. In some embodiments, the height of the protrusion structure 160 is no greater than about 5 mm. In other embodiments, as in the hole-type design shown in FIG. 12B, each pumping opening of the diagnostic cartridge 10 may be temporarily sealed by a sealing membrane 162, and the cartridge diagnostic base 30 may have needles capable of puncturing the sealing membrane 162 and being correctly inserted into the pumping openings.

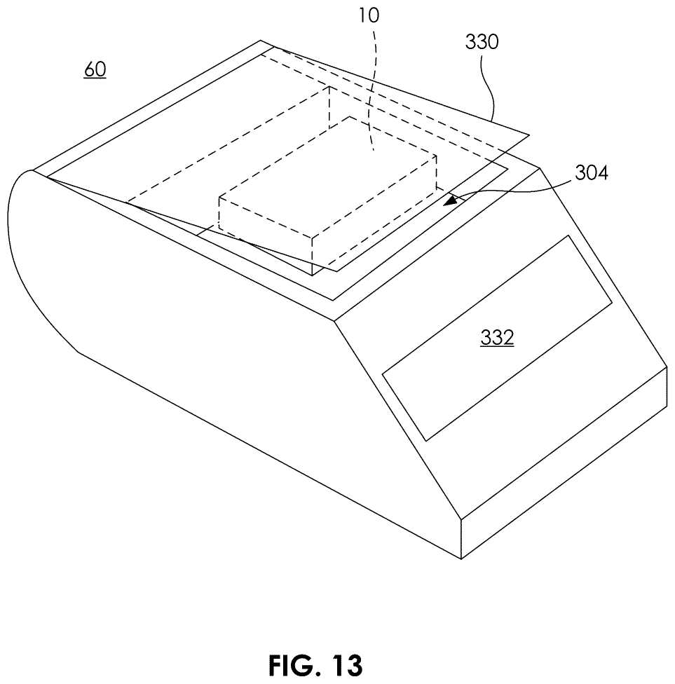

FIG. 13 illustrates an example of the semiconductor biosensor diagnostic system 60. As shown in the figure, the specific form of the cartridge diagnostic base 30 in the semiconductor biosensor diagnostic system 60 can be a desktop-type device, with the socket space 304 to accommodate the diagnostic cartridge 10. In some embodiments, the cartridge diagnostic base 30 has a cover 330 to enclose the socket space 304, which can serve as a mechanism to assist in pressing the diagnostic cartridge 10 into position. In some embodiments, the cartridge diagnostic base 30 includes a display screen 332 for users to observe diagnostic results or provide a mechanism for touch operation, such as running appropriate software to provide a user-friendly interface accordingly. In some embodiments, the cover 330 of the cartridge diagnostic base 30 may include a transparent window for user observation. In other embodiments, the cover 330 of the cartridge diagnostic base 30 may feature a central opening for operating the diagnostic cartridge 10, rather than fully covering the diagnostic cartridge 10 within the cartridge diagnostic base 30.

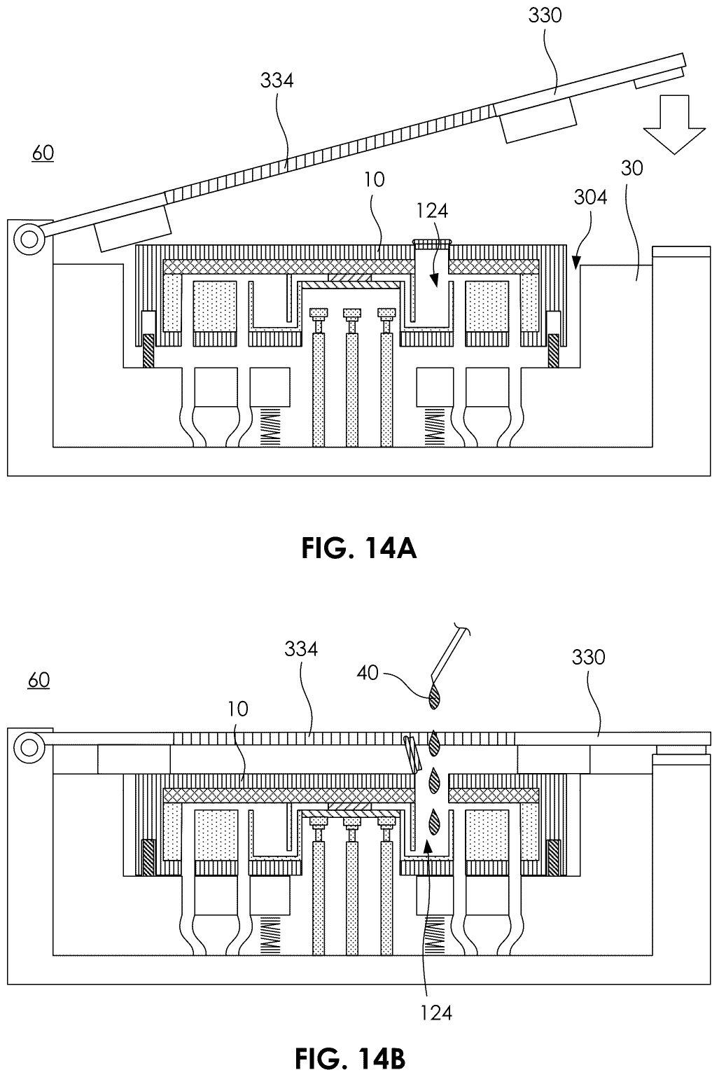

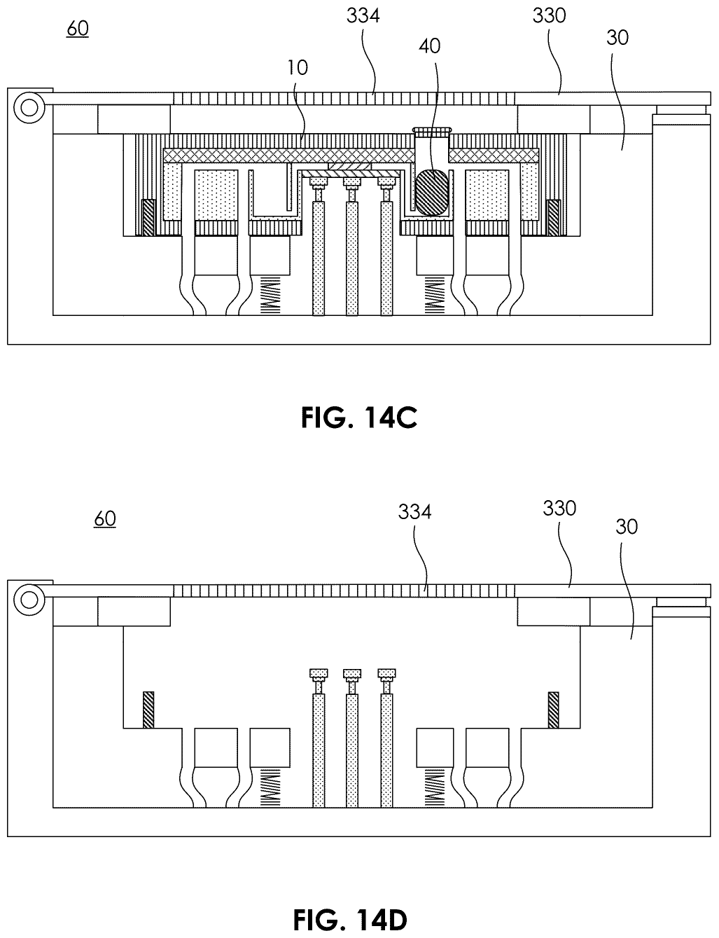

Referring to FIGS. 14A-14D, which illustrates cross-sectional views of an operating process of the semiconductor biosensor diagnostic system 60 according to some embodiments of the present disclosure. As illustrated in FIG. 14A, the diagnostic cartridge 10 can be inserted into the socket space 304 of the cartridge diagnostic base 30. Subsequently, pushing down the cover 330 of the cartridge diagnostic base 30 will ensure that the diagnostic cartridge 10 is securely positioned within the socket space 304. Moving on to FIG. 14B, in cases where the cover 330 includes a central opening 334, users may introduce the biomedical sample 40 into the diagnostic cartridge 10 through the central opening 334 (e.g., by vertically dropping the sample into the sample reservoir 124). Once the biomedical sample 40 is placed into the sample reservoir 124 of the diagnostic cartridge 10 and the cover 330 of the cartridge diagnostic base 30 is securely closed, as illustrated in FIG. 14C, the testing process of the biomedical sample 40 can commence. Upon completion of the test, as shown in FIG. 14D, the diagnostic cartridge 10 can be removed from the cartridge diagnostic base 30 for proper disposal or partial recycling.

Overall, the semiconductor biosensor diagnostic system in the present disclosure is a user-friendly system. The biosensor device in the diagnostic cartridge of the system may generate electrical signals for precision diagnosis. Users can inject the sample into the sample reservoir and subsequently place the diagnostic cartridge on the cartridge diagnostic base to accomplish the diagnosis operations. To be more detailed, the system in the present disclosure applies the pumping mechanism to the fluid-guide structure in the diagnostic cartridge to transport a buffer liquid cleaning the biosensor device, and the liquid biomedical sample can be measured by the biosensor device subsequently. Since the PCB that the biosensor device is mounted on a PCB having a plurality of probing pads, the cartridge diagnostic base of the system can read the electrical signal from the diagnostic cartridge quickly. Furthermore, the diagnostic cartridge and the cartridge diagnostic base can be combined simply by pushing the cartridge diagnostic towards the cartridge diagnostic base. Accordingly, the microcomputer can be used to control the pumping mechanism to perform the diagnosis and transfer the electrical bio-signal to a display screen, internet, or other reporting systems.

In one exemplary aspect, a semiconductor biosensor diagnostic system is provided. The semiconductor biosensor diagnostic system includes a diagnostic cartridge and a cartridge diagnostic base. The diagnostic cartridge includes a biosensor device, a fluid-guide body over the biosensor device configured to guide a sample and a buffer liquid to the biosensor device. The fluid-guide body includes a first pumping opening, a second pumping opening, a buffer reservoir, a sample reservoir, and a plurality of channels. The first pumping opening and the second pumping opening are in proximity to a side of the fluid-guide body. The buffer reservoir located in a region between the first pumping opening and the biosensor device. The sample reservoir is located in a region between the second pumping opening and the biosensor device. The plurality of channels is configured to provide a first loop comprising the first pumping opening and the buffer reservoir, and a second loop comprising the second pumping opening and the sample reservoir, wherein the first loop and the second loop sharing a common channel passing through the biosensor device. The cartridge diagnostic base includes a plurality of micro pumps coupled to the first pumping opening and the second pumping opening, and a sensing structure configured to receive a sensing information from the biosensor device.

In another exemplary aspect, a diagnostic cartridge is provided. The diagnostic cartridge includes a case body, a biosensor device, and a fluid-guide body. The case body has a recess. The biosensor device is embedded in the recess of the case body. The fluid-guide body is in the case body. The fluid-guide body includes a sample reservoir and a buffer reservoir laterally between the first pumping opening and the second pumping opening from a side view perspective; and a plurality of channels. One of the plurality of channels connects the sample reservoir and the buffer reservoir and crossing over the biosensor device, and the sample reservoir and the buffer reservoir further connecting with a pumping opening through the plurality of channels, respectively.

In yet another exemplary aspect, a diagnostic cartridge base is provided. The diagnostic cartridge base is configured to read an electrical signal from a diagnostic cartridge. The diagnostic cartridge base includes a cartridge carrier configured to place the diagnostic cartridge; a sensing structure configured to couple to a biosensor device of the diagnostic cartridge; a spring mechanism under the cartridge carrier, configured to apply a spring load toward a bottom of the cartridge diagnostic base when placing the diagnostic cartridge in the cartridge carrier; and a plurality of micro pumps configured to couple to a plurality of pumping openings of the diagnostic cartridge when placing the diagnostic cartridge in the cartridge carrier.

The foregoing outlines structures of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor biosensor diagnostic system, comprising:
a diagnostic cartridge, comprising:
a biosensor device;
a fluid-guide body over the biosensor device, configured to guide a sample and a buffer liquid to the biosensor device, the fluid-guide body comprises:
a first pumping opening in proximity to a side of the fluid-guide body;
a second pumping opening in proximity to the side of the fluid-guide body;
a buffer reservoir located in a region between the first pumping opening and the biosensor device;
a sample reservoir located in a region between the second pumping opening and the biosensor device; and
a plurality of channels configured to provide a first loop comprising the first pumping opening and the buffer reservoir, and a second loop comprising the second pumping opening and the sample reservoir, wherein the first loop and the second loop sharing a common channel passing through the biosensor device; and
a cartridge diagnostic base, comprising:
a plurality of micro pumps coupled to the first pumping opening and the second pumping opening; and
a sensing structure configured to receive a sensing information from the biosensor device.

2. The semiconductor biosensor diagnostic system of claim 1, wherein the buffer reservoir is connected to at least two of the plurality of channels.

3. The semiconductor biosensor diagnostic system of claim 1, wherein the fluid-guide body further comprises a waste reservoir in each of the first loop and the second loop.

4. The semiconductor biosensor diagnostic system of claim 3, wherein each of the waste reservoir is free from located on the common channel.

5. The semiconductor biosensor diagnostic system of claim 4, wherein the fluid-guide body further comprises a third pumping opening and fourth pumping opening connecting with the two waste reservoirs, respectively.

6. The semiconductor biosensor diagnostic system of claim 1, wherein the cartridge diagnostic base further comprises:
a cartridge carrier;
a spring mechanism under the cartridge carrier, configured to apply a spring load toward a bottom of the cartridge diagnostic base; and
at least two alignment pillars, and the diagnostic cartridge comprises at least two alignment trenches corresponding to the alignment pillars, respectively.

7. The semiconductor biosensor diagnostic system of claim 1, further comprising an optical transmissible substrate under the biosensor device.

8. A diagnostic cartridge, comprising:
a case body having a recess;
a biosensor device embedded in the recess of the case body;
a fluid-guide body in the case body, the fluid-guide body comprises:
a sample reservoir and a buffer reservoir laterally between the first pumping opening and the second pumping opening from a side view perspective; and
a plurality of channels, wherein one of the plurality of channels connects the sample reservoir and the buffer reservoir and crossing over the biosensor device, and the sample reservoir and the buffer reservoir further connecting with a pumping opening through the plurality of channels, respectively.

9. The diagnostic cartridge of claim 8, wherein the case body comprises a first opening with a first cover set over the sample reservoir.

10. The diagnostic cartridge of claim 8, wherein the case body comprises a second opening with a second cover set over the buffer reservoir configured to inject a buffer liquid.

11. The diagnostic cartridge of claim 8, wherein the fluid-guide body further comprises two waste reservoirs adjacent to the sample reservoir and the buffer reservoir, respectively.

12. The diagnostic cartridge of claim 11, further comprising a sealing membrane over the fluid-guide body, configured to seal the plurality of channels, the buffer reservoir, the sample reservoir, and the two waste reservoirs.

13. The diagnostic cartridge of claim 8, further comprising a substrate electrically coupled with the biosensor device, wherein the substrate comprises a plurality of metal pads at a lower surface of the substrate.

14. The diagnostic cartridge of claim 8, wherein the fluid-guide body further comprises a first pumping opening in proximity to a side of the fluid-guide body, and wherein the buffer reservoir is located in a region between the first pumping opening and the biosensor device.

15. The diagnostic cartridge of claim 8, wherein the fluid-guide body further comprises a second pumping opening in proximity to a side of the fluid-guide body, and wherein the sample reservoir is located in a region between the second pumping opening and the biosensor device.

16. The diagnostic cartridge of claim 8, wherein the biosensor device is packaged in an embedding module, and wherein the embedding module is detachable from the case body.

17. The diagnostic cartridge of claim 8, wherein each of the plurality of channels in a path between the sample reservoir and the buffer reservoir comprises a plurality of U-turn structures.

18. A diagnostic cartridge base, configured to read an electrical signal from a diagnostic cartridge, the diagnostic cartridge base comprises:
a cartridge carrier configured to place the diagnostic cartridge;
a sensing structure configured to couple to a biosensor device of the diagnostic cartridge;
a spring mechanism under the cartridge carrier, configured to apply a spring load toward a bottom of the cartridge diagnostic base when placing the diagnostic cartridge in the cartridge carrier; and
a plurality of micro pumps configured to couple to a plurality of pumping openings of the diagnostic cartridge when placing the diagnostic cartridge in the cartridge carrier.

19. The diagnostic cartridge base of claim 18, further comprising at least two alignment pillars on the cartridge carrier.

20. The diagnostic cartridge base of claim 19, wherein the alignment pillars are located asymmetrically to a center of a socket space of the cartridge carrier from a cross-sectional view perspective.
